(19) United States
(12) Patent Application Publication
(10) Pub. No.: US 2021/0039197 A1
(43) Pub. Date: Feb. 11, 2021

(54) PROCESSING PERFORMANCE CONFIRMATION METHOD FOR LASER PROCESSING APPARATUS

(71) Applicant: DISCO CORPORATION, Tokyo (JP)

(72) Inventor: Toshiyuki YOSHIKAWA, Tokyo (JP)

(21) Appl. No.: 16/983,413

(22) Filed: Aug. 3, 2020

(30) Foreign Application Priority Data
Aug. 8, 2019 (JP) 2019-146005

(51) Int. Cl. B23K 26/18; B23K 26/06; B23K 26/36; B23K 26/70; B23K 26/03

(52) U.S. Cl. CPC B23K 26/18; B23K 26/0665; B23K 26/032; B23K 26/36; B23K 26/70; B23K 26/0648

(57) ABSTRACT

A processing performance confirmation method for a laser processing apparatus that processes a workpiece with a laser beam of a wavelength having absorption in the workpiece. The method includes a holding step of holding the workpiece by a chuck table of the laser processing apparatus, a processing mark forming step of moving the workpiece and a condensing point of the laser beam relative to each other in a predetermined direction intersecting a thickness direction of the workpiece at right angles while changing the condensing point in height, thereby to form a processing mark on an upper surface of the workpiece, a imaging step of imaging a plurality of regions of the processing mark formed in the processing mark forming step, and a confirmation step of confirming processing performance of the laser processing apparatus based on images acquired in the imaging step.

### BACKGROUND OF THE INVENTION

### Field of the Invention

The present invention relates to a method for confirming processing performance of a laser processing apparatus that processes a workpiece with a laser beam of a wavelength having absorption in the workpiece.

### Description of the Related Art

Device chips for incorporation in a variety of electronic equipment are obtained by defining a front side of a wafer into plural regions with projected division lines (streets) arranged in a grid pattern, forming devices such as integrated circuits in the individual regions, and then dividing the wafer along the individual streets. When dividing a plate-shaped workpiece such as a wafer, a laser processing apparatus is used, for example. Such a laser processing apparatus includes a laser beam irradiation unit that can irradiate a laser beam of a wavelength having absorption in the workpiece (see, for example, JP 2007-275912 A).

The laser beam irradiation unit generally includes a laser oscillator, and an optical system having a plurality of optical components such as mirrors and lenses. A laser beam generated at the laser oscillator is guided to a workpiece by way of the optical system. The optical system includes a condenser lens for condensing the laser beam. If the laser beam has a wavelength that is absorbable in the workpiece, grooves or the like are formed in the workpiece through ablation processing when the laser beam is irradiated to the workpiece after having been focused by the condenser lens. However, the processing performance of the laser processing apparatus may change if a deviation occurs in the position, angle or the like of any of the optical components under vibrations, heat and/or the like. Such a change in the processing performance no longer permits adequate processing of the workpiece.

Accordingly, work may be conducted to confirm the height position of a condensing point by subjecting a workpiece to ablation processing on a trial basis with a condenser lens being positioned at heights different from a preset height (see, for example, JP 2013-78785 A). With the method described in JP 2013-78785 A, however, there is a need to form a plurality of linear processed grooves by positioning the condenser lens at a plurality of different heights and subjecting the workpiece to ablation processing with the condenser lens fixed at the individual heights. A problem hence arises in that the time required for the processing of the workpiece becomes longer as the number of the processing grooves increases. Moreover, if the number of processing grooves increases, a single piece of workpiece may not suffice, thereby possibly needing a plurality of workpieces. Accordingly, there is also a problem of an increase in the use area in a workpiece or the consumption of workpieces.

### SUMMARY OF THE INVENTION

With such problems in view, the present invention has as objects thereof a shortening of processing time and a reduction of the use area in a workpiece for test processing or the consumption of workpieces for test processing when confirming processing performance of a laser processing apparatus.

In accordance with an aspect of the present invention, there is provided a processing performance confirmation method for a laser processing apparatus that processes a workpiece with a laser beam of a wavelength having absorption in the workpiece. The processing performance confirmation method includes a holding step of holding the workpiece by a chuck table of the laser processing apparatus, a processing mark forming step of moving the workpiece and a condensing point of the laser beam relative to each other in a predetermined direction intersecting a thickness direction of the workpiece at right angles while changing the condensing point in height, thereby to form a processing mark on an upper surface of the workpiece, an imaging step of imaging a plurality of regions of the processing mark formed in the processing mark forming step, and a confirmation step of confirming processing performance of the laser processing apparatus based on a plurality of images acquired in the imaging step.

Preferably, in the imaging step, a first region, which includes a part where the processing mark has a smallest width in a direction intersecting the thickness direction and the predetermined direction at right angles, may be imaged, and the confirmation step may include a height position specifying step of specifying, based on an image of the first region, a height at which a condenser lens of the laser processing apparatus is positioned when the processing mark of the smallest width is to be formed.

Preferably, the confirmation step may include a deviation detection step of detecting, at each of at least two different regions, a deviation between a reference line, which is set in an imaging area of an imaging unit of the laser processing apparatus, and a center line, which is located at a widthwise center of the processing mark in a direction intersecting the predetermined direction at right angles and is parallel to the predetermined direction, and an adjustment need/not need determination step of determining, after the deviation detection step, that an adjustment of an optical system is not needed for irradiation of the laser beam to the workpiece if the deviation at each of the at least two different regions is within an acceptable range, but determining, after the deviation detection step, that an adjustment of the optical system is needed for the irradiation of the laser beam to the workpiece if the deviation at each of the at least two different regions is outside the acceptable range.

Preferably, the confirmation step may include a detection step of detecting a dark region, which has a brightness of not greater than a predetermined value, in an overall image of the processing mark formed based on the individual images of the plurality of regions imaged in the imaging step, a calculation step of calculating a range of height, which corresponds to the dark region, of a condenser lens of the laser processing apparatus, and a recording step of recording results of the calculation step, and the processing performance confirmation method may further include a time-dependent change confirmation step of repeating a plurality of times a series of steps including the processing mark forming step, the imaging step, the detection step, the calculation step, and the recording step, and comparing results of the series of steps recorded in the repetitions of the recording step, thereby to confirm changes with time of the processing performance of the laser processing apparatus.

In the processing performance confirmation method according to the aspect of the present invention for the laser processing apparatus, the workpiece and the condensing point of the laser beam are moved relative to each other in the predetermined direction intersecting the thickness direction of the workpiece at right angles while changing the condensing point in height, thereby to form the processing mark on the upper surface of the workpiece (processing mark forming step). Then, the processing mark formed in the processing mark forming step is imaged at a plurality of regions thereof (imaging step), and based on a plurality of images acquired in the imaging step, the processing performance of the laser processing apparatus is confirmed (confirmation step). By forming a single linear processing mark on the upper surface of a workpiece while changing the height of the condensing point of a laser beam as described above, it is possible to obtain results of the processing with the condensing point positioned at plural heights. The processing time can therefore be shortened compared with a case in which a plurality of linear processing marks is formed. In addition, desired processing results can be obtained by forming at least one linear processing mark. Compared with the case in which the plurality of linear processing marks is formed, the use area in a workpiece for test processing or the consumption of workpieces for test processing can hence be reduced.

The above and other objects, features and advantages of the present invention and the manner of realizing them will become more apparent, and the invention itself will best be understood from a study of the following description and appended claims with reference to the attached drawings depicting or illustrating some preferred embodiments of the invention.

### BRIEF DESCRIPTION OF THE DRAWINGS

FIG. 1 is a perspective view of a laser processing apparatus;

FIG. 2 is a partially cross-sectional side view of a workpiece and a condenser, which schematically illustrates a processing mark forming step;

FIG. 3 is a top plan view of the workpiece, which schematically illustrates a whole image of a processing mark;

FIG. 4 is a flow diagram of a processing performance confirmation method according to a first embodiment for the laser processing apparatus;

FIG. 5A is a schematic diagram of an image of a second region of a processing mark;

FIG. 5B is a schematic diagram of an image of a first region of the processing mark;

FIG. 5C is a schematic diagram of an image of a third region of the processing mark;

FIG. 6A is a schematic diagram of an image of a second region of another processing mark;

FIG. 6B is a schematic diagram of an image of a first region of the another processing mark;

FIG. 6C is a schematic diagram of an image of a third region of the another processing mark;

FIG. 7 is a flow diagram of a processing performance confirmation method according to a second embodiment for a laser processing apparatus;

FIG. 8A is a schematic diagram of a light/dark image of a first processing mark;

FIG. 8B is a schematic diagram of a light/dark image of a second processing mark;

FIG. 8C is a schematic diagram of a light/dark image of a third processing mark;

FIG. 8D is a schematic diagram of a light/dark image of a fourth processing mark;

FIG. 9 is a flow diagram of a processing performance confirmation method according to a third embodiment for a laser processing apparatus; and

FIG. 10 is a graph presenting widths of dark regions, which correspond to heights of a condenser lens.

### DETAILED DESCRIPTION OF THE PREFERRED EMBODIMENTS

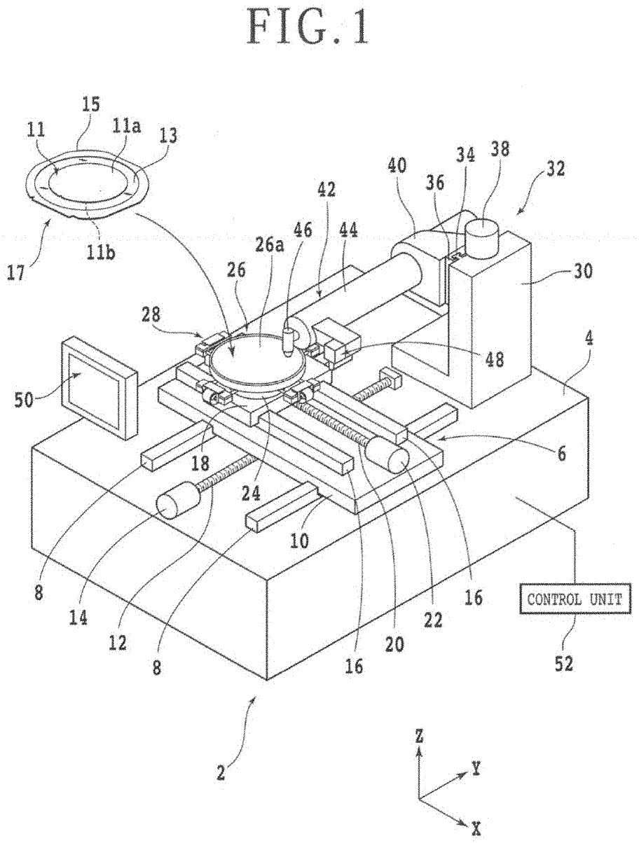

With reference to the attached drawings, a description will be made regarding embodiments of one aspect of the present invention. FIG. 1 is a perspective view of a laser processing apparatus 2. In FIG. 1, a constituent element of the laser processing apparatus 2 is presented as a functional block. Further, an X-axis direction (processing feed direction), a Y-axis direction (indexing feed direction), and a Z-axis direction (height direction), which will be referred to in the subsequent description, are perpendicular to one another. As depicted in FIG. 1, the laser processing apparatus 2 includes a base 4 that supports individual constituent elements. On an upper surface of the base 4, a horizontal moving mechanism (processing feed mechanism, indexing feed mechanism) 6 is arranged. The horizontal moving mechanism 6 has a pair of Y-axis guide rails 8, which are fixed on the upper surface of the base 4 and are substantially parallel to the Y-axis direction.

To the Y-axis guide rails 8, a Y-axis moving table 10 is slidably attached. On the side of a lower surface of the Y-axis moving table 10, a nut portion (not depicted) is arranged. To the nut portion of the Y-axis moving table 10, a Y-axis ball screw 12, which is substantially parallel to the Y-axis guide rails 8, is connected in a rotatable fashion. To an end portion of the Y-axis ball screw 12, a Y-axis pulse motor 14 is connected. When the Y-axis ball screw 12 is rotated by the Y-axis pulse motor 14, the Y-axis moving table 10 is moved in the Y-axis direction along the Y-axis guide rails 8.

On an upper surface of the Y-axis moving table 10, a pair of X-axis guide rails 16, which are substantially parallel to the X-axis direction, is arranged. To the X-axis guide rails 16, an X-axis moving table 18 is slidably attached. On the side of a lower surface of the X-axis moving table 18, a nut portion (not depicted) is arranged. To the nut portion of the X-axis moving table 18, an X-axis ball screw 20, which is substantially parallel to the X-axis guide rails 16, is connected in a rotatable fashion. To an end portion of the X-axis ball screw 20, an X-axis pulse motor 22 is connected. When the X-axis ball screw 20 is rotated by the X-axis pulse motor 22, the X-axis moving table 18 is moved in the X-axis direction along the X-axis guide rails 16.

On the side of an upper surface of the X-axis moving table 18, a cylindrical table base 24 is arranged. On an upper portion of the table base 24, a chuck table 26 is arranged. To a lower portion of the table base 24, a rotary drive source (not depicted), such as a motor, is connected. By force generated from the rotary drive source, the chuck table 26 is rotated about its axis of rotation that is substantially parallel to the Z-axis direction. Further, the table base 24 and the chuck table 26 are moved in the X-axis direction and the Y-axis direction by the above-mentioned horizontal moving mechanism 6.

On an outer peripheral portion of the chuck table 26, four clamps 28 are arranged to work in combination such that a ring-shaped metal frame 15 is fixed. On a portion of the chuck table 26, the portion being on the side of an upper surface of the chuck table 26, a disc-shaped porous plate formed, for example, with a porous material is arranged. The porous plate is connected to a suction source (not depicted), such as a vacuum ejector, via a suction line or the like (not depicted) arranged inside the chuck table 26. When the suction source is actuated, a negative pressure is generated on a substantially planar upper surface of the porous plate, so that the upper surface functions as a holding surface 26a that holds under suction a workpiece 11 or the like placed on the upper surface.

The workpiece 11 has a plate shape including an upper surface 11a and a lower surface 11b, which are substantially planner and are parallel to each other. The workpiece 11 in this embodiment is a wafer formed with silicon, but the workpiece 11 may also be formed with semiconductor other than silicon, ceramic, resin, metal, glass or the like. When processing the workpiece 11 by the laser processing apparatus 2, an adhesive tape (dicing tape) 13 of a diameter greater than that of the workpiece 11 is bonded to the lower surface 11b of the workpiece 11. In addition, the ring-shaped metal frame 15 is bonded to an outer peripheral portion of the adhesive tape 13. As a consequence, a frame unit 17 is formed with the workpiece 11 supported on the frame 15 via the adhesive tape 13.

In a region on one side of the horizontal moving mechanism 6 as viewed in the Y-axis redirection, a columnar support structure 30 is arranged. The columnar support structure 30 has a first side wall that is substantially perpendicular to the X-axis and Y-axis directions. On the first side wall of the support structure 30, a height adjusting mechanism 32 is disposed. The height adjusting mechanism 32 includes a pair of Z-axis guide rails 34, which are fixed on the first side wall and are substantially parallel to the Z-axis direction. To the Z-axis guide rails 34, a Z-axis moving table 36 is slidably attached.

On a back side (the side of the Z-axis guide rails 34) of the Z-axis moving table 36, a nut portion (not depicted) is arranged. To the nut portion of the Z-axis moving table 36, a Z-axis ball screw (not depicted), which is substantially parallel to the Z-axis guide rails 34, is rotatably connected. To an end portion of the Z-axis ball screw, a Z-axis pulse motor 38 is connected. When the Z-axis ball screw is rotated by the Z-axis pulse motor 38, the Z-axis moving table 36 is moved in the Z-axis direction along the Z-axis guide rails 34.

On a front side of the Z-axis moving table 36, a holder 40 is fixed, and a laser beam irradiation unit 42 is fixed at a portion thereof on the holder 40. The laser beam irradiation unit 42 has a laser oscillator (not depicted) fixed, for example, on the base 4. The laser oscillator includes a laser medium suited for laser oscillation, such as Nd:YAG, and generates a pulsed laser beam of a wavelength (for example, a wavelength of 355 nm) having absorption in the workpiece 11 (for example, average output: 1.0 W, repetition frequency: 10 kHz).

The generated laser beam is emitted toward the side of a cylindrical housing 44 fixed on the holder 40. The housing 44 accommodates therein a portion of an optical system that makes up the laser beam irradiation unit 42. This optical system primarily includes optical components such as mirrors and lenses. The housing 44 guides the laser beam, which has been radiated from the laser oscillator, to a condenser 46 arranged on an end portion of the housing 44 as viewed in the Y-axis direction.

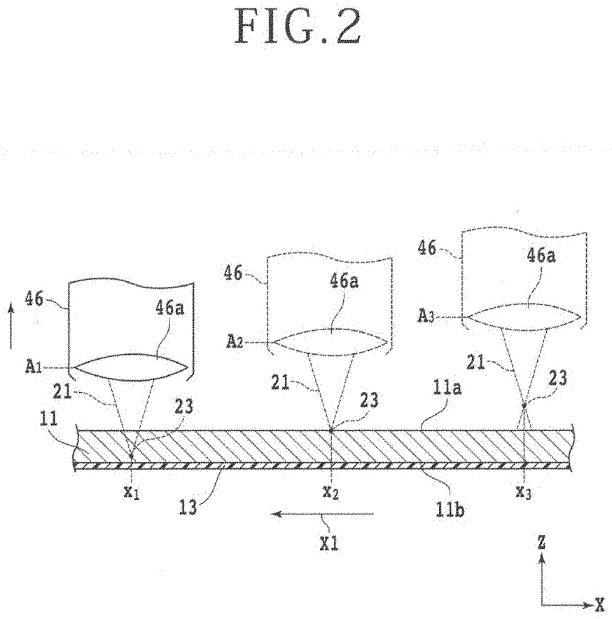

Another portion of the optical system, which makes up the laser beam irradiation unit 42, is arranged in the condenser 46. The laser beam is guided from the housing 44 to the condenser 46, and its path is deflected downward by a mirror (not depicted) or the like arranged in the condenser 46. Subsequently, the laser beam enters a condenser lens 46a (see FIG. 2) fixed inside the condenser 46. The laser beam is then irradiated from the condenser 46 to the workpiece 11 such that the laser beam is focused outside the condenser lens 46a.

In a region on one side of the condenser 46 as viewed in the X-axis direction, an imaging unit 48 is arranged. The imaging unit 48 is fixed on the housing 44 of the laser beam irradiation unit 42. The imaging unit 48 includes, for example, a complementary metal oxide semiconductor (CMOS) image sensor, a charge coupled device (CCD) image sensor, or the like. The imaging unit 48 is used when imaging the workpiece 11, which is held by the chuck table 26, on the side of its upper surface 11a. An upper section of the base 4 is covered by a cover (not depicted) that can accommodate the individual constituent elements therein. On a side wall of the cover, a touch panel display 50 is arranged as a user interface.

A variety of conditions, which will be applied when processing the workpiece 11, is inputted in the laser processing apparatus 2, for example, via the display 50. In addition, images generated at the imaging unit 48 are also displayed on the display 50. As readily appreciated from the foregoing, the display 50 functions as an input/output apparatus. Constituent elements such as the horizontal moving mechanism 6, the height adjusting mechanism 32, the laser beam irradiation unit 42, the imaging unit 48, and the display 50 are each connected to a control unit 52. The control unit 52 controls the above-mentioned individual constituent elements according to a series of steps needed for processing the workpiece 11.

The control unit 52 is configured of a computer that includes a processing apparatus such as a central processing unit (CPU) and a storage apparatus such as a flash memory. By operating the processing apparatus under software, such as programs, stored in the storage apparatus, the control unit 52 functions as specific means in which the software and the processing apparatus (a hardware resource) cooperate together. The control unit 52 includes an image processing section (not depicted) that performs processing for edge detection on images captured at the imaging unit 48. The image processing section also performs, in addition to the edge detection, image processing to stitch a plurality of images. Moreover, the image processing section also performs a measurement of a width and a length of each measurement target and a calculation of coordinates of edges of each measurement target.

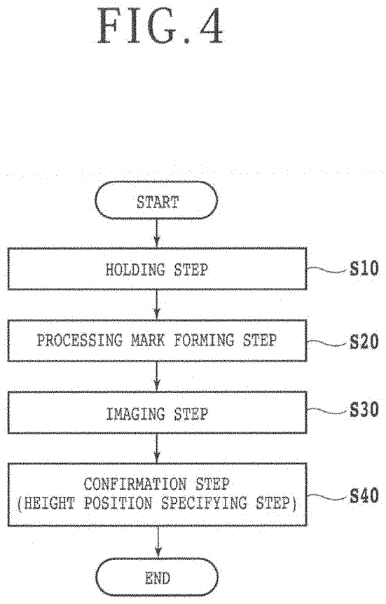

The control unit 52 also includes a calculation section (not depicted) that performs predetermined calculations. The calculation section calculates the coordinates of a condensing point 23 (see FIG. 2), the height of the condenser lens 46a, and the like based on a time t (specifically, a time elapsed from the time of initiation of processing), a moving speed Vx of the chuck table 26 in the X-axis direction, a moving speed Vz of the condenser lens 46a in the Z-axis direction, an initial position of the condenser lens 46a, and the like. With reference to FIGS. 2, 3 and 4, a description will next be made regarding a method for confirming processing performance of the laser processing apparatus 2 by processing the workpiece 11 with the laser processing apparatus 2. FIG. 4 is a flow diagram of a processing performance confirmation method according to the first embodiment for the laser processing apparatus 2.

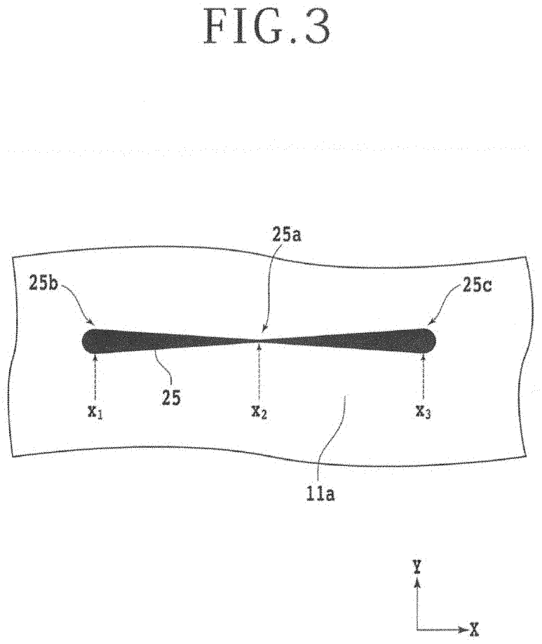

When processing the workpiece 11 with the laser processing apparatus 2, the frame unit 17 is first placed on the chuck table 26 such that the workpiece 11 is exposed at the upper surface 11a thereof. The suction source is then actuated to hold the workpiece 11 on the side of its lower surface 11b on the holding surface 26a via the adhesive tape 13 [holding step (S10)]. It is to be noted that at this time, the frame 15 is fixed at the four peripheral portions thereof by the four clamps 28. After the holding step (S10), the workpiece 11 is subjected to ablation processing on the side of its upper surface 11a, so that a processing mark 25 including a groove, roughness, or the like is formed on the upper surface 11a [processing mark forming step (S20)]. FIG. 2 is a partially cross-sectional side view of the workpiece 11 and the condenser 46, which schematically illustrates the processing mark forming step (S20). FIG. 3 is a top plan view of the workpiece 11, which schematically illustrates a whole image of the processing mark 25.

In the processing mark forming step (S20), the workpiece 11 and the condenser 46 are moved relative to each other in the X-axis direction by the horizontal moving mechanism 6 while moving the condenser 46 in the Z-axis direction by the height adjusting mechanism 32 with a laser beam 21 irradiated to the workpiece 11. As described above, in the processing mark forming step (S20) of this embodiment, dual axis moving processing is performed, specifically, the X-axis ball screw 20 of the horizontal moving mechanism 6 is moved while moving the Z-axis ball screw of the height adjusting mechanism 32 with the laser beam 21 irradiated to the workpiece 11.

When the chuck table 26 is moved in the X-axis direction (the direction of arrow X1) that intersects at right angles the thickness direction of the workpiece 11 held on the holding surface 26a via the adhesive tape 13 (in other words, the Z-axis direction), the workpiece 11 and the condenser lens 46a move relative to each other in the X-axis direction. The distance of the relative movement between the chuck table 26 and the condenser lens 46a is assumed to be 50 mm, for example. If the workpiece 11 and the condenser lens 46a are moved relative to each other in the X-axis direction with the laser beam 21 irradiated to the workpiece 11, the workpiece 11 is processed at the condensing point 23 that moves in the X-axis direction.

The condenser lens 46a is fixed inside the condenser 46, so that the movement of the condenser lens 46 can be equated with the movement of the condenser lens 46a. When the condenser lens 46a moves, the height of the condensing point 23 of the laser beam 21, which is focused at a predetermined height by the condenser lens 46a, also moves together. When the condenser lens 46a moves upward, for example, the condensing point 23 also moves upward. The distance of the movement of the condenser lens 46a is assumed to be, for example, 0.6 mm. In the processing mark forming step (S20), the condenser lens 46a is first positioned at a height A₁. The height Aₗ is set such that the distance between the condenser lens 46a and the upper surface 11a becomes smaller than the focal length of the condenser lens 46a. If the condenser lens 46a is at the height A₁, the condensing point 23 of the laser beam 21 is located lower than the upper surface 11a and inside the workpiece 11. In this case, the laser beam 21 comes into a so-called negative defocus (hereinafter “negative DF”) state. It is to be noted that at this time, the X-coordinate of the condensing point 23 is, for example, x₁.

Next, when the chuck table 26 is moved in the direction of arrow X1 while moving the condenser lens 46a upward, the condenser lens 46a reaches a height A₂. At this time, the distance between the condenser lens 46a and the upper surface 11a becomes, for example, equal to the focal length of the condenser lens 46a. If the distance between the height A₂ and the upper surface 11a is equal to the focal length of the condenser lens 46a, the laser beam 21 comes into a so-called just focus (hereinafter “JF”) state that its condensing point 23 is located on the upper surface 11a. It is to be noted that at this time, the X-coordinate of the condensing point 23 is x₂ located in a direction opposite to the arrow X1 relative to xₗ.

When the chuck table 26 is moved further in the direction of arrow X1 while further moving the condenser lens 46a upward, the condenser lens 46a reaches a height A₃. The height A₃ is set such that the distance between the condenser lens 46a and the upper surface 11a becomes greater than the focal length of the condenser lens 46a. If the condenser lens 46a is at the height A₃, the condensing point 23 of the laser beam 21 is located upper than the upper surface 11a. In this case, the laser beam 21 comes into a so-called positive defocus (hereinafter “positive DF”) state. It is to be noted that at this time, the X-coordinate of the condensing point 23 is x₃ located in the direction opposite to the arrow X1 relative to x₂.

If the condenser lens 46a is located at the height A₂, the processing mark 25 located at x₂ has a width (a length in the Y-axis direction) that, as presented at a first region 25a of FIG. 3, is smallest compared with the widths of other positions of the processing mark 25 in the X-axis direction. If the condenser lens 46a is located at the height A₁ or the height A₃, on the other hand, the laser beam 21 is irradiated to a broad area of the upper surface 11a compared with the case in which the condenser lens 46a is located at the height A₂.

Therefore, the processing mark 25 has greater widths at x₁ and x₃ than the width of the processing mark 25 at x₂. As illustrated in FIG. 3, a second region 25b (a region including x₁) and a third region 25c (a region including x₃) are regions having great widths compared with the first region 25a. As described above, the formation of the single linear processing mark 25 on the upper surface 11a while continuously changing the height of the condensing point 23 of the laser beam 21 allows to obtain processing results including an amount of information corresponding to that available if the condensing point 23 is positioned at a plurality of heights.

Hence, the processing time can be shortened compared with the case in which a plurality of linear processing grooves is formed in a workpiece while positioning a condenser lens at a plurality of different heights. In addition, the formation of at least one linear processing mark 25 enables to obtain desired processing results, and therefore the use area in a workpiece 11 for test processing or the consumption of workpieces 11 for test processing can be reduced compared with the case in which a plurality of linear processing grooves is formed. After the processing mark forming step (S20), a plurality of regions including the above-mentioned first region 25a, second region 25b, and third region 25c is imaged by the imaging unit 48 [imaging step (S30)]. Based on the images acquired in the imaging step (S30), the processing performance of the laser processing apparatus 2 is then confirmed [confirmation step (S40)].

In the confirmation step (S40) of the first embodiment, based on the image of the first region 25a, the height of the condenser lens 46a (in other words, the condenser 46) upon formation of the processing mark 25 of the smallest width is specified (height position specifying step). Described more specifically, the image processing section of the control unit 52 first specifies the X-coordinate (in other words, x₂ mentioned above) of the condensing point 23 when the processing mark 25 has the smallest width in the image of the first region 25a. The calculation section of the control unit 52 next calculates the time t (in other words, the time elapsed from the time of initiation of processing) when the condensing point 23 is at x₂. Based on the time t, a moving speed Vz, the initial position of the condenser lens 46a, and the like, a calculation is then performed to obtain the height (Z-coordinate) of the condenser lens 46a when the condensing point 23 is at x₂.

In this embodiment, the formation of the single linear processing mark 25 enables, as described above, to specify the height of the condenser lens 46a when the condensing point 23 is at x₂. Compared with the case in which a plurality of processing grooves is formed to confirm the height of a condensing point, it is accordingly possible to shorten the processing time and also to reduce the use area in the workpiece 11 or the consumption of the workpieces 11. It is to be noted that, if the laser processing apparatus 2 is continuously used for a certain time or longer, the height of the condensing point 23 may change due to thermal lensing or the like induced in the condenser lens 46a. Such changes in the height of the condensing point 23 (in other words, time-dependent changes in the processing performance of the laser processing apparatus 2) can also be confirmed if the steps S10 to S40 described in this embodiment are repeated a plurality of times.

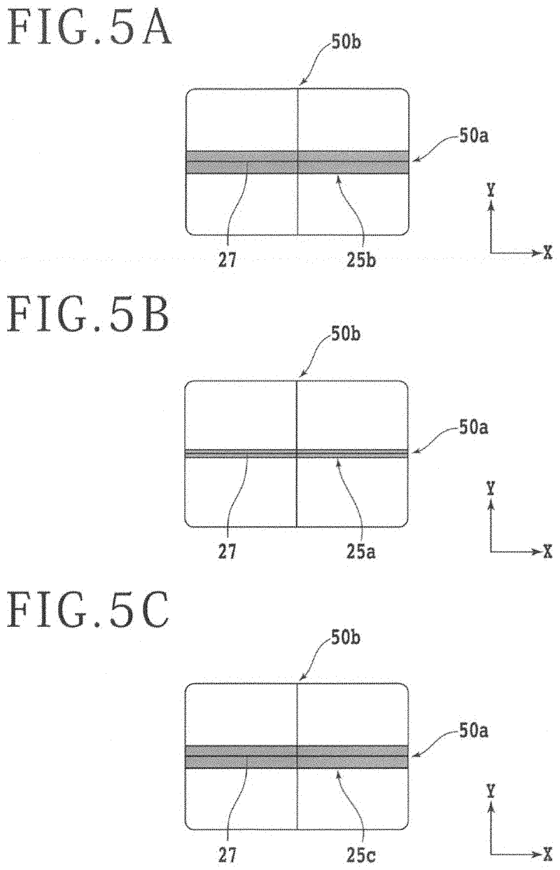

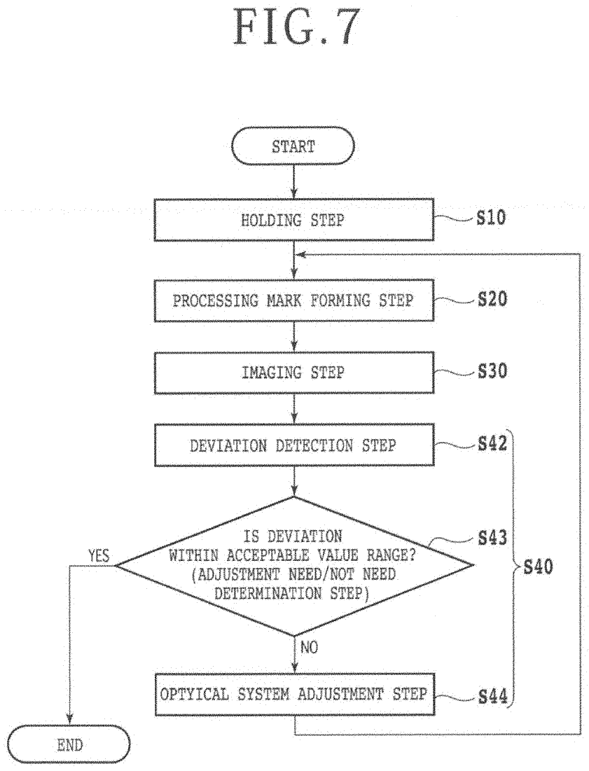

With reference to FIGS. 5A to 5C, FIGS. 6A to 6C, and FIG. 7, a description will next be made regarding a method for confirming processing performance according to a second embodiment for a laser processing apparatus 2. FIG. 7 is a flow diagram of a processing performance confirmation method according to the second embodiment for the laser processing apparatus 2. In the second embodiment, the holding step (S10), the processing mark forming step (S20), and the imaging step (S30) are performed as in the first embodiment. In a confirmation step (S40) of the second embodiment, however, a deviation detection step (S42) is performed to detect deviations between a reference line and a center line that is located along widthwise center of a processing mark 25 in the Y-axis direction and is parallel to the X-axis direction.

FIGS. 5A to 5C are schematic diagrams of images of the processing mark 25 to be used in the deviation detection step (S42). The images illustrated in the schematic diagrams of FIGS. 5A to 5C are acquired while parallelly moving a workpiece 11 in the X-axis direction by the horizontal moving mechanism 6 with the imaging unit 48 positioned over the processing mark 25. FIG. 5A is the schematic diagram of the image of a second region 25b of the processing mark 25, FIG. 5B is the schematic diagram of the image of a first region 25a of the processing mark 25, and FIG. 5C is the schematic diagram of the image of a third region 25c of the processing mark 25. It is to be noted that the images used in the deviation detection step (S42) are different from the images captured in the imaging step (S30) in that a first reference line 50a, which is parallel to the X-axis direction, and a second reference line 50b, which is parallel to the Y-axis direction, have been added.

The first reference line 50a and the second reference line 50b are not formed on the actual processing mark 25, but are set in an imaging area when the processing mark 25 is imaged by the imaging unit 48. The first reference line 50a and the second reference line 50b form a cross line to indicate a center of the imaging area. It is to be noted that the first reference line 50a has the same Y-coordinate in FIGS. 5A to 5C. In FIGS. 5A to 5C, a center line 27 is also illustrated. This center line 27 is located along the centers in the Y-axis direction of the processing mark 25 in each region. It is also to be noted that the center line 27 and the first reference line 50a overlap each other in FIGS. 5A to 5C.

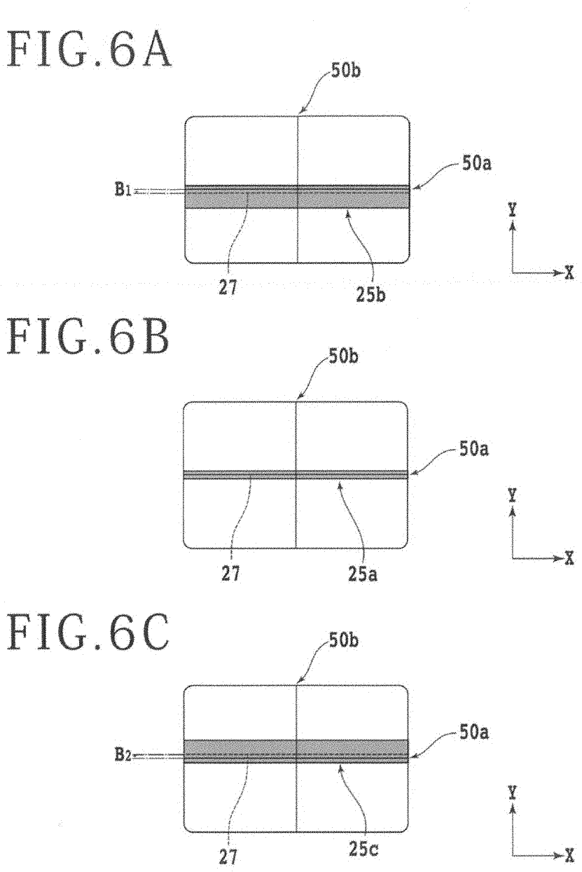

In the deviation detection step (S42), for example, the control unit 52, for example, its image processing section detects deviations B, which correspond, for example, to a deviation B₁ indicated in FIG. 6A and a deviation B₂ indicated in FIG. 6C, between the first reference line 50a and the center line 27 in the Y-axis direction. It is to be noted that an executive entity for the deviation detection step (S42) is not limited to the control unit 52 but can be an operator. In the deviation detection step (S42), the deviations B between the first reference line 50a and the center line 27 in the Y-axis direction in the second region 25b and the third region 25c are detected with the Y-coordinate of the first reference line 50a and that of the center line 27 being coincided with each other, for example, in the first region 25a (FIG. 5B). An acceptable range is set beforehand for the deviations B. The acceptable range for the deviations B is, for example, −5 μm and greater and +5 μm and smaller, more preferably −3 μm and greater and +3 μm and smaller. In this embodiment, it is assumed that the deviations B are assumed to be negative if the center line 27 is located on one side of the first reference line 50a in the Y-axis direction and the deviations B are positive if the center line 27 is located on the other side of the first reference line 50a in the Y-axis direction.

In the confirmation step (S40) of the second embodiment, an adjustment need/not need determination step (S43) is performed to determine, based on the deviations B detected in the deviation detection step (S42), whether an adjustment is needed for the optical system to irradiate the laser beam 21 to the workpiece 11. In the case of the processing mark 25 illustrated in FIGS. 5A to 5C, these deviations B are substantially zero. In the first region 25a, the second region 25b, and the third region 25c, the deviations B are within the acceptable range. If this is the case, the control unit 52 determines that an adjustment of the optical system is not needed (YES in S43).

However, the position at which the laser beam 21 is irradiated to the workpiece 11 may change according to a deviation of the position, the angle, or the like of an optical component such as a mirror or a lens. For example, the laser beam 21 may enter the condenser lens 46a with an inclination to the optical axis of the condenser lens 46a according to a deviation of the position, the angle, or the like of an optical component. If this is the case, the irradiation position of the laser beam 21 changes compared with that in a case in which the laser beam 21 enters the condenser lens 46a in parallel to its optical axis.

FIGS. 6A to 6C are schematic diagrams of images of another processing mark 25 formed through the steps S10 and S20. The images illustrated in the schematic diagrams of FIGS. 6A to 6C are acquired while parallelly moving a workpiece 11 in the X-axis direction by the horizontal moving mechanism 6 with the imaging unit 48 positioned over the another processing mark 25. FIG. 6A is the schematic diagram of the image of a second region 25b of the another processing mark 25, FIG. 6B is the schematic diagram of the image of a first region 25a of the another processing mark 25, and FIG. 6C is the schematic diagram of the image of a third region 25c of the another processing mark 25.

In the deviation detection step (S42) on the another processing mark 25, the image processing section also detects deviations B between a first reference line 50a and a center line 27 in the Y-axis direction. In FIG. 6A, the center line 27, which is indicated by a broken line, is at a position apart by 10 μm toward one side of the Y-axis direction from the first reference line 50a. In other words, a deviation B₁ (−10 μm) between the center line 27 and the first reference line 50a is outside the acceptable range. In FIG. 6C, the center line 26, which is indicated by a broken line, is located on the other side of the Y-axis direction with respect to the first reference line 50a, and a deviation B₂ (+10 μm) between the center line 27 and the first reference line 50a is also outside the acceptable range. In FIG. 6B, on the other hand, the center line 27 and the first reference line 50a overlap each other, so that the deviations B between the center line 27 and the first reference line 50a are within the acceptable range.

As described above, the deviations B in the Y-axis direction between the center line 27 and the first reference line 50a are outside the acceptable range in the second region 25b (FIG. 6A) and the third region 25c (FIG. 6C) (NO in S43). If this is the case, the control unit 52 determines in the adjustment need/not need determination step (S43) that an adjustment is needed for the optical system to irradiate the laser beam 21 to the workpiece 11. In the second embodiment, a deviation of the optical system of the laser processing apparatus 2 can be confirmed by forming the single linear processing mark 25. It is accordingly possible to confirm whether or not the laser beam 21 is entering with an inclination to the optical axis of the condenser lens 46a.

After confirming the processing performance of the laser processing apparatus 2 as described above, the operator adjusts, for example, the position, the angle, or the like of an optical component such as a mirror, a lens, or the like [optical system adjusting step (S44)]. After the optical system adjusting step (S44), the steps S20 to S43 are performed again. If the deviations B in the at least two different regions such as those including the second region 25b and the third region 25 are within the acceptable range, the flow of the processing performance confirmation method according to the second embodiment for the laser processing apparatus 2 is then ended. If the deviations B are outside the acceptable range, however, the step S44 and the steps S20 to S43 are repeated until there no longer exist the deviations B.

It is to be noted that FIGS. 5B and 6B present the examples in which the first reference line 50a and the center line 27 are arranged overlapping each other. However, the first reference line 50a may be arranged at a position apart from the center line 27 by a predetermined distance C in the Y-axis direction. If this is the case, values obtained by subtracting the predetermined distance C from the deviations B between the first reference line 50a and the center line 27 (specifically, the magnitudes of B minus C) are detected as actual deviations in the deviation detection step (S42). Corresponding to whether or not these actual deviations are within the acceptable range, a determination is then made in the adjustment need/not need determination step (S43) as to whether an adjustment of the optical system is needed or not needed. It is to be noted that the regions of the processing mark 25, which are subjected to the imaging and detection in the imaging step (S30) and the deviation detection step (S42), are not limited only to the second region 25b and the third region 25c but may be any regions if they include two or more desired regions of the processing mark 25.

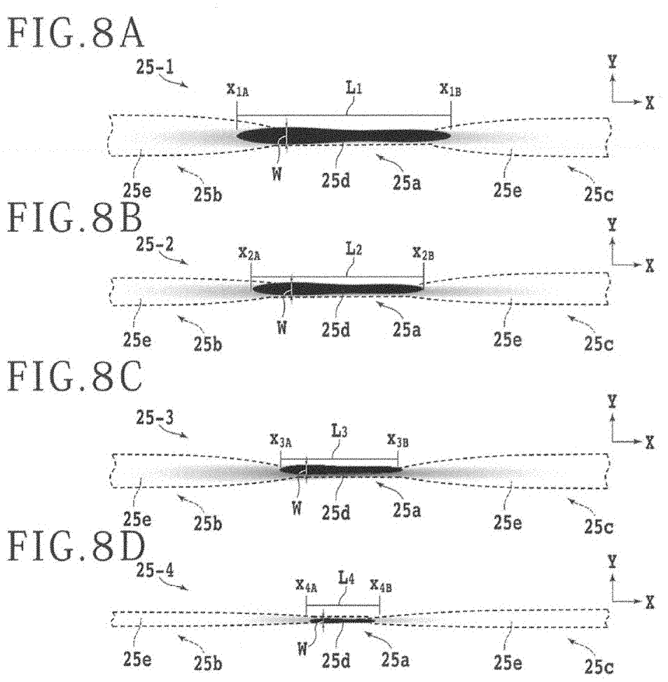

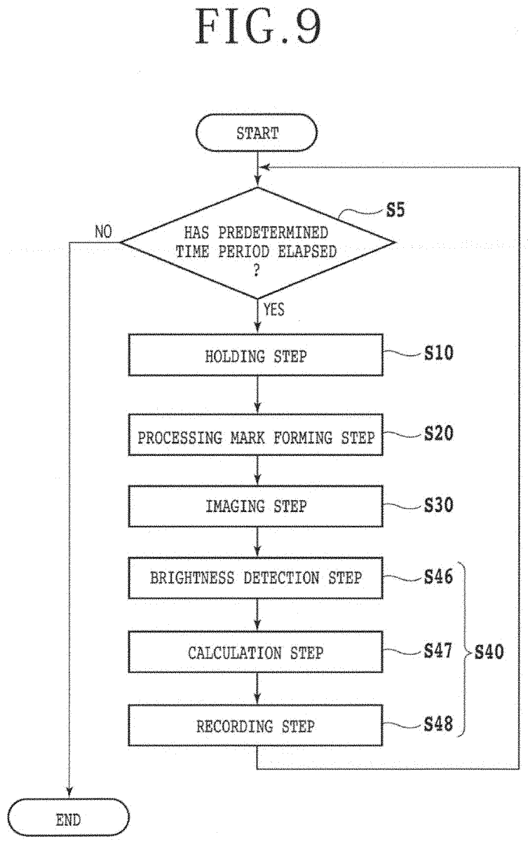

Using FIGS. 8A to 8D and FIG. 9, a description will next be made regarding a processing performance confirmation method according to a third embodiment for a laser processing apparatus 2. FIG. 9 is a flow diagram of the processing performance confirmation method according to the third embodiment for the laser processing apparatus 2. In the third embodiment, a control unit 52 first determines whether or not a predetermined time period (for example, several hours, a day, a week, or a month) has elapsed since the last confirmation of the processing performance of the laser processing apparatus 2 [time period elapse determination step (S5)]. It is to be noted that the operator may determine whether or not the predetermine time period has elapsed.

If the predetermined time period has not elapsed (NO in S5), a display is made accordingly on the display 50. If this is the case, processing of a workpiece 11 is not performed. If the predetermined time period has elapsed (YES in S5), however, a display is made accordingly on the display 50. If YES in S5, the operator, for example, sends a command to the control unit 52 via the display 50 to initiate processing. As a consequence, the processing of the workpiece 11 is initiated, and similar to the first embodiment, the holding step (S10), a processing mark forming step (S20), and an imaging step (S30) are sequentially performed.

In the processing mark forming step (S20) of the third embodiment, one or more (for example, four) processing marks 25 are formed in respective different regions on the side of an upper surface 11a of the workpiece 11. In the imaging step (S30), the chuck table 26 is then moved in the X-axis direction with the imaging unit 48 positioned above one of the processing marks 25. In this manner, the one processing mark 25 is imaged in the plural regions thereof. In the imaging step (S30), the individual regions are imaged, for example, such that the imaged regions partially overlap one another. The image processing section of the control unit 52 then stiches the plural regions together, so that a whole image of the one processing mark 25 is formed. In a similar manner, whole images of the individual processing marks 25 are acquired.

In a first region 25a and its vicinity, the upper surface 11a is processed with energy greater than a processing threshold for the workpiece 11. Roughness is formed in the region processed with the energy greater than the processing threshold. This region is therefore imaged as a dark region 25d of a brightness having a predetermined value or smaller for such a reason that light is diffusely reflected (see FIGS. 8A to 8D). In a second region 25b and a third region 25c and their vicinities, on the other hand, the workpiece 11 is processed on the side of the upper surface 11a with energy smaller than the processing threshold for the workpiece 11. The regions processed with the energy smaller than the processing threshold become light regions 25e of a brightness greater than the predetermined value as opposed to the first region 25a (see FIGS. 8A to 8D). It is to be noted that in FIGS. 8A to 8D, broken lines are drawn along contours of the light regions 25e.

In the imaging step (S30) of the third embodiment, light/dark images are acquired each including a relatively blackish dark region 25d and relatively whitish light regions 25e. FIG. 8A is a schematic diagram of the light/dark image of a first processing mark 25-1 when the processing mark forming step (S20) has been performed with the average output of the laser beam 21 set at 1.0 W. In the confirmation step (S40) of the third embodiment, an image processing section of a control unit 52, instead of the step S40 of the first embodiment, first detects the dark region 25d of the at least one processing mark 25 [detection step (S46)].

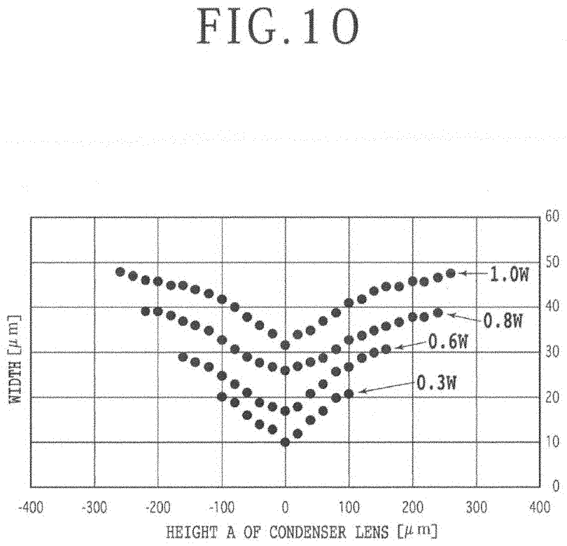

After the detection step (S46), a calculation section of the control unit 52 calculates the range of a height A (see FIG. 10) of the condenser lens 46a, which corresponds to a length L of the dark region 25d of the at least one processing mark 25 in the X-axis direction [calculation step (S47)]. Calculated are, for example, the height (lower end) of the condenser lens 46a corresponding to the X-coordinate (x_{1A}) of an end portion on the other side of the dark region 25d of the first processing mark 25-1 in the X-axis direction, and the height (upper end) of the condenser lens 46a corresponding to the X-coordinate (x_{1B}) of an end portion on the one side of the dark region 25d of the first processing mark 25-1 in the X-axis direction. The range of the height A of the condenser lens 46a so calculated is recorded in the storage apparatus of the control unit [recording unit (S48)].

The series of steps, which includes the holding step (S10), the processing mark forming step (S20), the imaging step (S30), the detection step (S46), the calculation step (S47), and the recording step (S48) as described above, is performed in every predetermined time period (for example, every several hours, every day, every week, or every month). In each recording step (S48), the results of the series of steps performed as described above are recorded. A comparison among the results of the series of steps recorded in the repetitions of the recording step (S48) enables to confirm time-dependent changes of the processing performance of the laser processing apparatus 2 (time-dependent change confirmation step). For example, by observing time-dependent changes of the range of the height A of the condenser lens 46a corresponding to the length of the dark region 25d of the processing mark 25, which has been formed by the laser beam 21 of the average output of 1.0 W, in the X-axis direction as recorded in every predetermined time period, it is possible to determine whether or not any abnormality has occurred on the laser beam irradiation unit 42. In the repetitions of the recording step (S48) described above, the range of the height A corresponding to the first processing mark 25-1 is recorded. As an alternative, a plurality of processing marks 25 may be formed, and the time-dependent change confirmation step may then be performed on each processing mark 25.

FIG. 8B is a schematic diagram of the light/dark image of a second processing mark 25-2 when the processing mark forming step (S20) has been performed with the average output of the laser beam 21 set at 0.8 W. FIG. 8C is a schematic diagram of the light/dark image of a third processing mark 25-3 when the processing mark forming step (S20) has been performed with the average output of the laser beam 21 set at 0.6 W. Further, FIG. 8D is a schematic diagram of the light/dark image of a fourth processing mark 25-4 when the processing mark forming step (S20) has been performed with the average output of the laser beam 21 set at 0.3 W. The length L of the dark region 25d in the X-axis direction becomes shorter as the average output decreases. The first processing mark 25-1 illustrated in FIG. 8A has a greatest length L₁, and the second processing mark 25-2 illustrated in FIG. 8B has a length L₂ shorter than the length L₁. Further, the third processing mark 25-3 illustrated in FIG. 8C has a length L₃ shorter than the length L₂, and the fourth processing mark 25-4 illustrated in FIG. 8D has a length L₄ shorter than the length L₃.

When performing the time-dependent change confirmation step on each processing mark 25, the detection step (S46), the calculation step (S47), and the recording step (S48) are performed on each of the first processing mark 25-1 to the fourth processing mark 25-4. In the calculation step (S47), the ranges of heights A of the condenser lens 46a corresponding to coordinates x_{2A} and x_{2B} located at the opposite ends of the dark region 25d of the second processing mark 25-2 in the X-axis direction are calculated. Further, the ranges of heights A of the condenser lens 46a corresponding to coordinates x_{3A} and x_{3B} located at the opposite ends of the dark region 25d of the third processing mark 25-3 in the X-axis direction are calculated.

In addition, the ranges of heights A of the condenser lens 46a corresponding to coordinates x_{4A} and x_{4B} located at the opposite ends of the dark region 25d of the fourth processing mark 25-4 in the X-axis direction are calculated. The ranges of the individual heights A as calculated above are then recorded in the recording step (S48). As a consequence, time-dependent changes of the processing performance of the laser processing apparatus 2 can be confirmed. In this embodiment, the formation of the plural processing marks 25 with the laser beams 21 of the different average outputs enables to specify the range of the height A of the condenser lens 46a, which forms the dark region 25d corresponding to each average out of the laser beam 21. It is therefore also possible to specify optimal processing conditions (for example, the value of an optimal average output greater than the processing threshold for the workpiece 11) for the workpiece 11.

In the detection step (S46) mentioned above, the length L of the dark region 25d in the X-axis direction is detected. In addition to this length L, the width W of the dark region 25d in the Y-axis direction may also be detected further. Corresponding to this width W, the height A of the condenser lens 46a may also be calculated in the calculation step (S47). FIG. 10 is a graph presenting the widths W of the dark regions 25d corresponding to the heights A of the condenser lens 46a. The abscissa in FIG. 10 sets the height A, at which the condensing point 23 comes into a JF state, to be zero, represents, as negative, heights A at which the condensing point 23 comes into a negative DF state, and represents, as positive, heights A at which the condensing point 23 comes into a positive DF state. On the other hand, the ordinate in FIG. 10 represents the width W of each dark region 25d.

The calculated range of the height A is recorded in the storage apparatus of the control unit [recording step (S48)]. The series of steps, which includes the detection step (S46), the calculation step (S47), and the recording step (S48), is then repeated in every predetermined time period (for example, every several hours, every day, every week, or every month). In the plural repetitions of the recording step (S48), the results of the series of the steps performed as described above are recorded. A comparison among the results of the series of steps recorded in the repetitions of the recording step (S48) enables to confirm time-dependent changes of the processing performance of the laser processing apparatus 2. As illustrated in FIG. 10, the ranges of the heights A corresponding to all of the first processing mark 25-1 to the fourth processing mark 25-4 are recorded in the repetitions of the recording step (S48). As an alternative, however, the range of the height A corresponding to at least one processing mark 25 may also be recorded.

Furthermore, the structures, the methods, and the like according to the above-described embodiments can be practiced with changes or modifications as needed insofar as such changes or modifications do not depart from the extent of the objects of the present invention. For example, the first embodiment, the second embodiment, and the third embodiment may be combined together. In addition, the workpiece 11 and the condenser lens 46a may be moved relative to each other in the Y-axis direction instead of the X-axis direction although they are moved relative to each other in the X-axis direction in the above-described embodiments.

The present invention is not limited to the details of the above-described preferred embodiments. The scope of the invention is defined by the appended claims and all changes and modifications as fall within the equivalence of the scope of the claims are therefore to be embraced by the invention.

What is claimed is:

1. A processing performance confirmation method for a laser processing apparatus that processes a workpiece with a laser beam of a wavelength having absorption in the workpiece, the method comprising:
a holding step of holding the workpiece by a chuck table of the laser processing apparatus;
a processing mark forming step of moving the workpiece and a condensing point of the laser beam relative to each other in a predetermined direction intersecting a thickness direction of the workpiece at right angles while changing the condensing point in height, thereby to form a processing mark on an upper surface of the workpiece;
an imaging step of imaging a plurality of regions of the processing mark formed in the processing mark forming step; and
a confirmation step of confirming processing performance of the laser processing apparatus based on a plurality of images acquired in the imaging step.

2. The processing performance confirmation method according to claim 1, wherein
in the imaging step, a first region, which includes a part where the processing mark has a smallest width in a direction intersecting the thickness direction and the predetermined direction at right angles, is imaged, and
the confirmation step includes
a height position specifying step of specifying, based on an image of the first region, a height at which a condenser lens of the laser processing apparatus is positioned when the processing mark of the smallest width is to be formed.

3. The processing performance confirmation method according to claim 1, wherein
the confirmation step includes
a deviation detection step of detecting, at each of at least two different regions, a deviation between a reference line, which is set in an imaging area of an imaging unit of the laser processing apparatus, and a center line, which is located at a widthwise center of the processing mark in a direction intersecting the predetermined direction at right angles and is parallel to the predetermined direction, and
an adjustment need/not need determination step of determining, after the deviation detection step, that an adjustment of an optical system is not needed for irradiation of the laser beam to the workpiece if the deviation at each of the at least two different regions is within an acceptable range, but determining, after the deviation detection step, that an adjustment of the optical system is needed for the irradiation of the laser beam to the workpiece if the deviation at each of the at least two different regions is outside the acceptable range.

4. The processing performance confirmation method according to claim 1, wherein
the confirmation step includes
a detection step of detecting a dark region, which has a brightness of not greater than a predetermined value, in an overall image of the processing mark formed based on the individual images of the plurality of regions imaged in the imaging step,
a calculation step of calculating a range of height, which corresponds to the dark region, of a condenser lens of the laser processing apparatus, and
a recording step of recording results of the calculation step,
the processing performance confirmation method further comprising:
a time-dependent change confirmation step of repeating a plurality of times a series of steps including the processing mark forming step, the imaging step, the detection step, the calculation step, and the recording step, and comparing results of the series of steps recorded in the repetitions of the recording step, thereby to confirm changes with time of the processing performance of the laser processing apparatus.
